(19) United States
(12) Patent Application Publication
(10) Pub. No.: US 2003/0230947 A1
(43) Pub. Date: Dec. 18, 2003

(54) Fault tolerant motor actuator for steer by wire system

(76) Inventors: Mohammad S. Islam, Saginaw, MI (US); Tomy Sebastian, Saginaw, MI (US)

Correspondence Address: KEITH J. MURPHY, CANTOR COLBURN LLP, 55 Griffin Road South, Bloomfield, CT, 06002, US

(21) Appl. No.: 10/172,081

(22) Filed: Jun. 14, 2002

(51) Int. Cl. H02K 21/12

(52) U.S. Cl. 310/156.47

(57) ABSTRACT

A fault tolerant electric motor for steering actuation is disclosed. In an exemplary embodiment, the motor includes a stator assembly having a first group of stator windings and a second group of stator windings, thereby forming a redundant pair of stator windings. The first and second groups of stator windings are located within opposite hemispheres of the stator assembly. A rotor assembly is rotatingly disposed within the stator assembly, and has a plurality of magnets disposed around the periphery of a rotor core. Each of the plurality of magnets is arranged into a pair of segments, one of which is shifted from the other with respect to an axis of rotation of the rotor assembly.

### BACKGROUND

The present disclosure relates generally to electric motor actuators and, more particularly, to a fault tolerant motor actuator that may be implemented in a steer by wire system.

A steer by wire system is a system in which one or more steerable wheels are controlled according to an input from a device such as a steering wheel or a handwheel. Generally speaking, the angular displacement of the steering wheel inputted by an operator is detected by a sensor in the form of an electrical signal, and an electric motor is then used to actuate the steerable wheels according to this electrical signal. In addition, the handwheel typically also has a motor actuator associated therewith to provide tactile feedback to the operator. As can be appreciated, the use of electric motors in this type of environment mandates a fairly high degree of reliability associated therewith, as there is no mechanical connection between the steering wheel and the steerable wheels. Thus, it is not uncommon for these systems to provide for some type of redundancy, whether the redundancy is achieved through duplicate electric machinery or by including redundant windings within the electric motor actuators themselves.

However, in addition to reliability, it is also desirable to simultaneously address the problem of motor performance, especially for an application such as steer by wire. A primary concern for electric motors used in steering applications in general (especially for those motors mechanically coupled to a steering wheel) is that of torque ripple. The main sources of torque ripple include cogging torque and ripple torque, the ripple torque being a result of the harmonic contents in the line-to-line back-emf. The cogging torque is a result of the magnetic interaction between the permanent magnets of the rotor and the slotted structure of the armature in a brushless electric motor. As the leading edge of a magnet approaches an individual stator tooth, a positive torque is produced by the magnetic attraction force exerted therebetween. However, as the magnet leading edge passes and the trailing edge approaches, a negative torque is produced. The instantaneous value of the cogging torque varies with rotor position and alternates at a frequency that is proportional to the motor speed and the number of slots. The amplitude of the cogging torque is affected by certain design parameters such as slot opening/slot pitch ratio, magnet strength and air gap length.

Existing approaches to improving torque performance include the use of skewed, arc-shaped magnets that increases the complexity and costs of the manufacturing process. Furthermore, motors with relatively high number of slots (e.g., 27-slot/6-pole, 24-slot/6-pole) also increase the manufacturing and winding costs. Accordingly, it is desirable to be able to implement a motor actuator for a system (such as a steer by wire system) that provides both fault tolerance and acceptable torque performance, but that is also relatively simple in design and inexpensive to manufacture.

### SUMMARY

The above discussed and other drawbacks and deficiencies of the prior art are overcome or alleviated by a fault tolerant electric motor for steering actuation. In an exemplary embodiment, the motor includes a stator assembly having a first group of stator windings and a second group of stator windings, thereby forming a redundant pair of stator windings. The first and second groups of stator windings are located within opposite hemispheres of the stator assembly. A rotor assembly is rotatingly disposed within the stator assembly, and has a plurality of magnets disposed around the periphery of a rotor core. Each of the plurality of magnets is arranged into a pair of segments, one of which is shifted from the other with respect to an axis of rotation of the rotor assembly.

In a preferred embodiment, the stator assembly further includes a plurality of stator teeth, each having a pair of grooves formed within inward facing ends thereof. Each of the segments of the plurality of magnets further includes a substantially flat shaped inner surface and a substantially circular outer surface. In addition, each segment has a width of about 76.5 mechanical degrees with respect to the axis of rotation, and one of the pair of segments is shifted from the other of the pair of segments by about 15 mechanical degrees with respect to the axis of rotation.

In another aspect, an actuator for a steering system includes an electric motor having a stator assembly and a rotor assembly rotatingly disposed within the stator assembly. The stator assembly has a first group of stator windings and a second group of stator windings, thereby forming a redundant pair of stator windings. The first and the second group of stator windings are located within opposite hemispheres of said stator assembly. The stator assembly further includes a plurality of stator teeth each having a pair of slots formed within inward facing ends thereof. The rotor assembly has a plurality of magnets disposed around the periphery of a rotor core, wherein each of the plurality of magnets is arranged into a pair of segments, one of the pair of segments being shifted from the other of the pair of segments with respect to an axis of rotation of the rotor assembly.

In another aspect, a steer-by-wire system for a vehicle includes a master control unit responsive to a steering wheel position signal from a steering wheel unit, and a road wheel unit responsive to a road wheel command signal generated by the master control unit for steering the vehicle. The steering wheel unit further includes a motor actuator for providing tactile feedback to an operator of the vehicle. The motor actuator has a stator assembly with a first group of stator windings and a second group of stator windings, thereby forming a redundant pair of stator windings. The first and second groups of stator windings are located within opposite hemispheres of the stator assembly. A rotor assembly is rotatingly disposed within the stator assembly, the rotor assembly having a plurality of magnets disposed around the periphery of a rotor core. Each of the plurality of magnets is arranged into a pair of segments, one of the pair of segments being shifted from the other of the pair of segments with respect to an axis of rotation of the rotor assembly.

### BRIEF DESCRIPTION OF THE DRAWINGS

Referring to the exemplary drawings wherein like elements are numbered alike in the several Figures:

FIG. 1 is a cross-sectional view of a brushless electric motor in accordance with an embodiment of the invention;

FIG. 2 is a side view of the rotor assembly of the motor shown in FIG. 1;

FIG. 3 is a perspective view of the rotor assembly shown in FIG. 2;

FIG. 4 illustrates the cogging torque performance of the motor configuration of FIG. 1;

FIG. 5 illustrates the line-to-line back-emf performance of the motor configuration of FIG. 1; and

FIG. 6 is a system block diagram illustrating an exemplary steer-by-wire system that may employ the brushless electric motor of FIG. 1.

### DETAILED DESCRIPTION

Disclosed herein is a brushless electric motor, which may be used as an actuator in a steering system such as a steer by wire system. It should be appreciated however, that the specific application of the motor is not necessarily limited to a steer by wire system or even to a steering system in general. Rather, it is contemplated the following motor embodiment(s) may be implemented as an actuator in any application where redundancy, torque performance and cost are of concern.

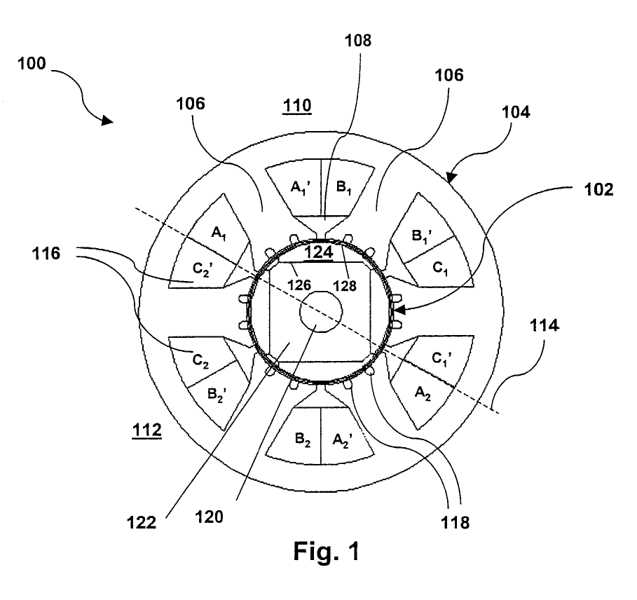

Referring initially to FIG. 1, there is shown a cross-sectional view of a brushless electric motor 100 in accordance with an embodiment of the invention. The motor 100 includes a rotor assembly 102 rotatingly disposed within a stator assembly 104. The stator assembly 104 features a plurality of salient stator teeth 106, defining a plurality of corresponding slots 108 therebetween. As can be seen from the embodiment depicted, the stator assembly 104 has a total of six slots 108. The stator assembly further includes a first set of stator windings 110 and a second set of stator windings 112, disposed within opposite hemispheres of the stator 104, as indicated by the dashed line 114. Thus configured, the motor 100 is provided with a redundant pair of stator windings.

Within each hemisphere, individual phase windings 116 are wound around each of the stator teeth 106. In the example illustrated, there are a total of three phase windings 116 wound around the three corresponding stator teeth of the first hemisphere, the three windings labeled as A₁-A₁′, B₁-B₁′, and C₁-C₁′. Similarly, there are three phase windings 116 wound around the stator teeth of the second hemisphere, labeled A₂-A₂′, B₂-B₂′, and C₂-C₂′. This concentrated winding arrangement allows for a relatively inexpensive manufacturing process, in addition to a redundant set of windings. Effectively, two motors reside within the stator assembly. When configured as a single motor, the first and second sets of stator windings 110, 112 are connected in parallel. Alternatively, each set may be connected to separate power supplies in a fully redundant arrangement. Moreover, since each set of stator windings is within a separate hemisphere, there exists complete decoupling therebetween. Because each slot 108 simultaneously houses two separate phase windings, appropriate electrical isolation is disposed therebetween. It will also be seen in FIG. 1 that the stator teeth 106 each include a pair of “dummy slots” or grooves 118 formed in the inward ends thereof. As will be described in further detail, the grooves 118 are used to reduce the amplitude of the cogging torque, while increasing the frequency of the cogging.

The rotor assembly 102 includes a shaft 120 protruding from a core 122 that is preferably made from a plurality of lamina of iron, steel, or other magnetic material. In addition, there are four “bread-loaf” rotor magnets 124 disposed around the circumference of the core, thereby forming a four-pole motor. As seen in the cross-sectional view of FIG. 1, the term “bread-loaf” is used to describe the general shape of the rotor magnets 124, in that they have a flat inner surface 126 and a circular outer surface 128.

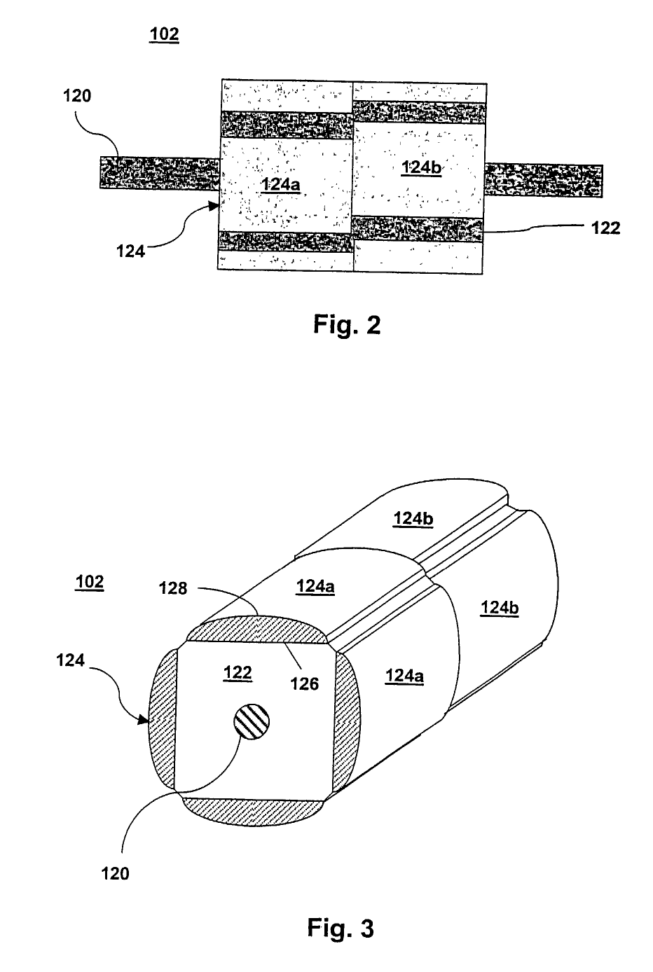

As a result of the formation of the grooves 118 within the stator teeth 106, a cogging component of 36 pulses per revolution (in addition to the 12 pulses per revolution caused by the stator teeth 106 without the grooves) is introduced into the motor. In order to cancel these cogging components, each magnet 124 is segmented into two pieces, which are shifted by about 15 mechanical degrees from one another with respect to the axis of rotation of the rotor assembly 102. This segmentation and shifting of the segments is shown in further detail in FIGS. 2 and 3. As can be seen, each of the magnets 124 is each divided into a pair of segments, designated 124a and 124b. In this configuration, the individual magnet segments (having edges perpendicular to the axis of the motor shaft 120) are easier to manufacture than a skewed arc magnet.

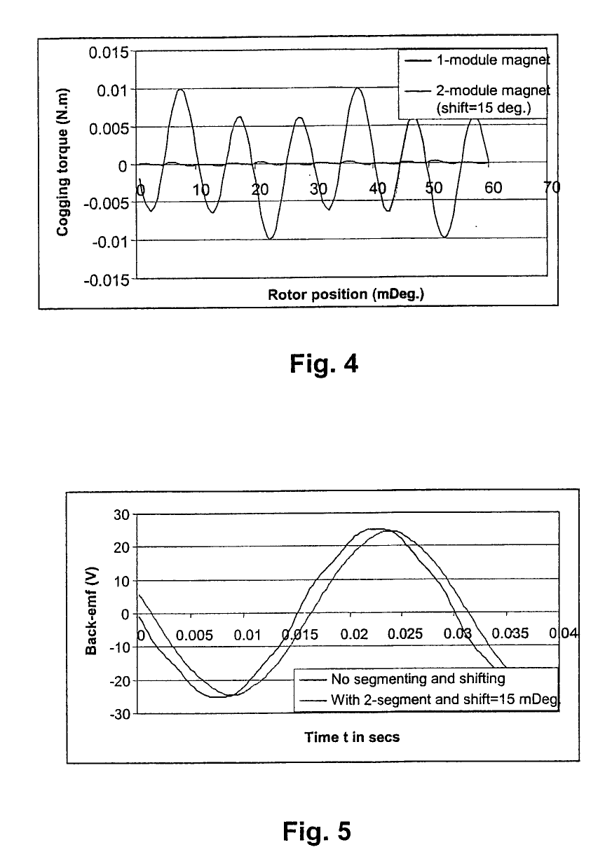

Various simulations were run with the above-described rotor assembly configuration in order to optimize the design. While the magnet width cannot be optimized for both cogging and harmonics, the cogging amplitude is minimized by introducing dummy-slotted teeth and segmented magnets. FIG. 4 is a graph illustrating the cogging torque performance of the segmented and shifted rotor magnets 124, as compared with a design utilizing single-piece magnets. As is seen in the graph, there is significantly less cogging torque ripple with the segmented/shifted rotor magnet configuration. Particularly, the shifting of the magnet segments by 15 mechanical degrees causes the canceling of both 12 and 36 pulse per revolution cogging components.

In order to improve the harmonic performance, the magnet width of each segment was selected to be about 76.5 mechanical degrees, a width wherein both the 5^{th} and 7^{th} harmonic components in the motor-induced voltage are at a minimum and are about equal to one another. In addition, the shifting also reduces the amplitude of the 5^{th} and 7^{th} harmonic components by almost 75%. For the non-segmented configuration, the peak-to-peak cogging torque is about 20 milli-Newton meters (mN·m), whereas for the segmented configuration, the peak-to-peak cogging torque is less than 1.0 mN·m. FIG. 5 illustrates the line-to-line back-emf for designs with and without magnet segmentation and shifting. As is shown, the resultant harmonic content of both 5^{th} and 7^{th} harmonics is around 0.5% of the fundamental frequency with the magnet segmenting and shifting. This is an improvement over the back-emf waveform without segmenting and shifting, wherein the harmonic content is about 2-3%.

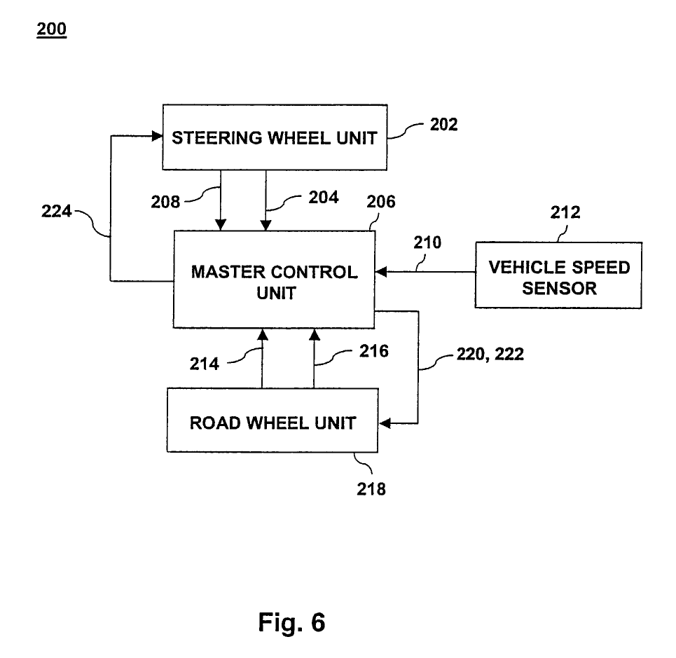

Finally, FIG. 6 is a system block diagram illustrating an exemplary steer-by-wire system 200 in which the above described motor 100 may be used as an actuator. A steering wheel unit 202 detects the position and movement of a steering wheel (not shown) and sends a steering wheel position signal 204 to a master control unit 206. The master control unit 206 combines the information of the steering wheel position signal 204, a feedback torque sensor signal 208, with a vehicle speed signal 210 from a vehicle speed sensor 212 and tie-rod force signals 214, 216 from a road wheel unit 218. Using these input signals, the master control unit 206 produces road wheel command signals 220, 222 (one for a left and right road wheel respectively) that are sent to the road wheel unit 218. In addition, a steering wheel torque command signal 224 is sent from the master control unit 206 to the steering wheel unit 202.

Thus, in one aspect, the motor 100 may be included as an actuator within the steering wheel unit 202 to provide tactile feedback to an operator of the vehicle. In another aspect, the motor 100 may also be used in the road wheel unit 218 to produce the steering angle on the steerable wheels.

The above described motor design provides a robust, cost effective, reliable solution for applications such as steering actuators. In one aspect, a 6-slot, 4-pole device allows for a simpler stator winding process, wherein redundant windings are disposed in opposing hemispheres of the stator assembly. Thereby, the redundant pair of windings are also decoupled from another. In a further aspect, the motor torque ripple performance is enhanced through the grooves formed within the stator teeth, as well as by the magnet width of the “bread-loaf” rotor magnet configuration. By configuring the magnets in a segmented, shifted arrangement, the harmonic components in the line-to-line back emf and cogging torque are also minimized.

While the invention has been described with reference to a preferred embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electric motor, comprising:
a stator assembly having a first group of stator windings and a second group of stator windings, thereby forming a redundant pair of stator windings, said first and said second group of stator windings further being located within opposite hemispheres of said stator assembly; and
a rotor assembly, rotatingly disposed within said stator assembly, said rotor assembly having a plurality of magnets disposed around the periphery of a rotor core;
wherein each of said plurality of magnets is arranged into a pair of segments, one of said pair of segments being shifted from the other of said pair of segments with respect to an axis of rotation of said rotor assembly.

2. The electric motor of claim 1, wherein said stator assembly further comprises a plurality of stator teeth, each of said plurality of stator teeth having a pair of grooves formed within inward facing ends thereof.

3. The electric motor of claim 1, wherein each of said segments of said plurality of magnets further comprises a substantially flat shaped inner surface and a substantially circular outer surface.

4. The electric motor of claim 3, wherein each of said segments of said plurality of magnets has a width of about 76.5 mechanical degrees with respect to said axis of rotation.

5. The electric motor of claim 3, wherein said one of said pair of segments is shifted from the other of said pair of segments by about 15 mechanical degrees with respect to said axis of rotation.

6. The electric motor of claim 1, wherein said stator assembly comprises six slots and said rotor assembly comprises four poles.

7. An actuator for a steering system, comprising:
an electric motor having a stator assembly and a rotor assembly rotatingly disposed within said stator assembly;
said stator assembly having a first group of stator windings and a second group of stator windings, thereby forming a redundant pair of stator windings, said first and said second group of stator windings further being located within opposite hemispheres of said stator assembly;
said stator assembly further including a plurality of stator teeth each having a pair of grooves formed within inward facing ends thereof; and
said rotor assembly having a plurality of magnets disposed around the periphery of a rotor core, wherein each of said plurality of magnets is arranged into a pair of segments, one of said pair of segments being shifted from the other of said pair of segments with respect to an axis of rotation of said rotor assembly.

8. The actuator of claim 7, wherein each of said segments of said plurality of magnets further comprises a substantially flat shaped inner surface and a substantially circular outer surface.

9. The actuator of claim 8, wherein each of said segments of said plurality of magnets has a width of about 76.5 mechanical degrees with respect to said axis of rotation.

10. The actuator of claim 9, wherein said one of said pair of segments is shifted from the other of said pair of segments by about 15 mechanical degrees with respect to said axis of rotation.

11. The actuator of claim 10, wherein said stator assembly comprises six slots and said rotor assembly comprises four poles.

12. The actuator of claim 11, wherein each slot within said stator assembly houses a pair of electrically isolated phase windings therein.

13. A steer-by-wire system for a vehicle, comprising:
a master control unit responsive to a steering wheel position signal from a steering wheel unit;
a road wheel unit responsive to a road wheel command signal generated by said master control unit for steering the vehicle; and
said steering wheel unit further comprising a motor actuator for providing tactile feedback to an operator of the vehicle, said motor actuator further comprising:
a stator assembly having a first group of stator windings and a second group of stator windings, thereby forming a redundant pair of stator windings, said first and said second group of stator windings further being located within opposite hemispheres of said stator assembly; and
a rotor assembly, rotatingly disposed within said stator assembly, said rotor assembly having a plurality of magnets disposed around the periphery of a rotor core;
wherein each of said plurality of magnets is arranged into a pair of segments, one of said pair of segments being shifted from the other of said pair of segments with respect to an axis of rotation of said rotor assembly.

14. The steer-by-wire system of claim 13, wherein said stator assembly further comprises a plurality of stator teeth, each of said plurality of stator teeth having a pair of grooves formed within inward facing ends thereof.

15. The steer-by-wire system of claim 13, wherein each of said segments of said plurality of magnets further comprises a substantially flat shaped inner surface and a substantially circular outer surface.

16. The steer-by-wire system of claim 15, wherein each of said segments of said plurality of magnets has a width of about 76.5 mechanical degrees with respect to said axis of rotation.

17. The steer-by-wire system of claim 15, wherein said one of said pair of segments is shifted from the other of said pair of segments by about 15 mechanical degrees with respect to said axis of rotation.

18. The steer-by-wire system of claim 13, wherein said stator assembly comprises six slots and said rotor assembly comprises four poles.
